(19) United States
(12) Patent Application Publication
(10) Pub. No.: US 2010/0108641 A1
(43) Pub. Date: May 6, 2010

(54) LAVACOAT PRE-CLEAN AND PRE-HEAT

(75) Inventors: Brian T. West, San Jose, CA (US); Wendell Boyd, JR., Morgan Hill, CA (US); Samantha Tan, Union City, CA (US)

Correspondence Address: PATTERSON & SHERIDAN, LLP - - APPM/TX, 3040 POST OAK BOULEVARD, SUITE 1500, HOUSTON, TX, 77056, US

(73) Assignee: APPLIED MATERIALS, INC., Santa Clara, CA (US)

(21) Appl. No.: 12/570,219

(22) Filed: Sep. 30, 2009

Related U.S. Application Data
(60) Provisional application No. 61/102,808, filed on Oct. 3, 2008.

(51) Int. Cl. B44C 1/22

(52) U.S. Cl. 216/94

(57) ABSTRACT

Embodiments described herein provide methods of surface preparation using an electromagnetic beam prior to modification of the surface of a component which advantageously improve the quality of the final texture in those places and correspondingly reduces particle contamination. In one embodiment a method of providing a texture to a surface of a component for use in a semiconductor processing chamber is provided. The method comprises defining a plurality of regions on the surface of a component, moving an electromagnetic beam to a first region of the plurality of regions, scanning the electromagnetic beam across a surface of the first region to heat the surface of the first region, and scanning the electromagnetic beam across the heated surface of the first region to form a feature.

### CROSS-REFERENCE TO RELATED APPLICATIONS

This application claims benefit of U.S. provisional patent application Ser. No. 61/102,808, filed Oct. 3, 2008, which is herein incorporated by reference.

### BACKGROUND OF THE INVENTION

1. Field of the Invention

Embodiments of the invention generally relate to a method of using a beam of electromagnetic radiation to modify the surface of a material. More particularly, embodiments of the invention relate to a method of surface preparation using an electromagnetic beam prior to modification of the surface of a component used in a process chamber.

2. Description of the Related Art

As integrated circuit devices continue to be fabricated with reduced dimensions, the manufacture of these devices becomes more susceptible to reduced yields due to contamination. Consequently, fabricating integrated circuit devices, particularly those having smaller physical sizes, requires that contamination be controlled to a greater extent than previously considered to be necessary.

Contamination of integrated circuit devices may arise from sources such as undesirable stray particles impinging on a substrate during thin film deposition, etching or other semiconductor fabrication processes. In general, the manufacturing of the integrated circuit devices includes the use of such chambers as physical vapor deposition (PVD) sputtering chambers, chemical vapor deposition (CVD) chambers, plasma etching chambers, etc. During the course of deposition and etch processes, materials often condense from the gas phase onto various internal surfaces in the chamber and on chamber components to form solid masses that reside on the chamber and component surfaces. This condensed foreign matter accumulates on the surfaces and is prone to detaching or flaking off from the surfaces in between or during a wafer process sequence. This detached foreign matter may then impinge upon and contaminate the wafer substrate and devices thereon. Contaminated devices frequently must be discarded, thereby decreasing the manufacturing yield of the process.

In order to prevent detachment of foreign matter that has condensed on the surfaces of process chamber components, these surfaces may be textured such that the condensed foreign matter that forms on these surfaces has enhanced adhesion to the surface and is less likely to detach and contaminate a wafer substrate.

One such texturizing process exposes a component to sufficient directed energy to melt and re-shape material on the surface of the component to form a textured surface.

However, deposits existing on the surface of the component prior to texturing the component as well as the sometimes considerable quantities of re-deposited metal and metal oxides which condense on the component surfaces as a by-product of the texturizing process can effect the texture formation and the adhesion of reflowed material ejected from formed cavities during the texturizing process to the component surface. In addition splatter from the texturizing process can leave small pieces of metal loosely adhered to the metal oxide coated and as yet un-textured surfaces thus degrading the quality of the final texture in those places.

In addition, existing texturizing processes may not yield adequate texture shape or size with a single pass of the texturing energy beam. Also, in some cases the material ejected from the component may not fuse well to the component surface if that surface is too cold.

Therefore, there is a need for an improved texturizing process.

### SUMMARY OF THE INVENTION

Embodiments of the invention provide a method of surface preparation using an electromagnetic beam prior to modification of the surface of a component with the electromagnetic beam. Embodiments described herein provide for superior pre-cleaning of the surfaces to be textured as an integral part of the texturizing process, thus eliminating the opportunity for post-cleaning contamination from either handling of the component or re-deposition of evaporated or ejected material to the component surface. Embodiments described herein further augment existing texturing methodology to include a pass of an energy beam over the surfaces to be textured immediately prior to the texturing pass thus pre-heating the surface to improve both texture formation and the fusion of ejected material to the component surface.

In one embodiment a method of providing a texture to a surface of a component for use in a semiconductor processing chamber is provided. The method comprises defining a plurality of regions on the surface of the component, moving an electromagnetic beam to a first region of the plurality of regions, scanning the electromagnetic beam across a surface of the first region to heat the surface of the first region, and scanning the electromagnetic beam across the heated surface of the first region to form a feature.

In another embodiment a method of providing a texture to a surface of a component for use in a semiconductor processing chamber is provided. The method comprises scanning an electromagnetic beam across a first region of a plurality of regions of the surface of the component for a first time period to pre-clean the surface of the first region of the component without melting the component and scanning the electromagnetic beam across the first region of the surface of the component for a second time period to form a feature on the first region of the surface of the component, wherein the second time period occurs immediately after completion of the first time period.

In yet another embodiment a method of providing a texture to a surface of a component for use in a semiconductor processing chamber is provided. The method comprises scanning an electromagnetic beam across a first region of a plurality of regions of the surface of a component for a first time period to melt the surface of the component and scanning the electromagnetic beam across the first region of the surface of the component for a second time period to form a feature on the first region of the surface of the component, wherein the second time period occurs immediately after the first time period.

In yet another embodiment, a metal component is provided. The metal component comprises an annular body having a plurality of features comprising protuberances and depressions formed therein, wherein the protuberances are generated in the dead soft-state to reduce the temper of the metal and insure the ability of the component to yield and conform during clamping of other parts around the component.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 depicts a schematic, cross-sectional view of a surface texturing apparatus that may be used to practice embodiments described herein;

FIG. 2 depicts a schematic, cross-sectional view of a control system that may be coupled to a surface texturing apparatus to practice embodiments described herein;

FIG. 3A depicts a process that may be used to pre-clean a material prior to modification of the surface of the material according to embodiments described herein;

FIG. 3B depicts a process that may be used to pre-heat a material prior to modification of the surface of the material according to embodiments described herein;

FIG. 4 depicts a top view of a component and features formed thereon according to embodiments described herein;

FIG. 5A depicts a perspective view of a component according to embodiments described herein; and

FIG. 5B depicts a partial side view of the component of FIG. 5A.

To facilitate understanding, identical reference numerals have been used, where possible, to designate identical elements that are common to the figures. It is contemplated that elements disclosed in one embodiment may be beneficially utilized on other embodiment without specific recitation.

### DETAILED DESCRIPTION

Embodiments described herein utilize the extremely high energy density and fast traverse speeds possible with an energy beam type of texturizing process to remove surface contamination from the material surface as an integral part of the texturizing process. Cleaning the surfaces prior to the texturizing process utilizing the energy beam is done in-situ by scanning the beam across the surface of the component in the areas to be textured just prior to the texturing pass by the beam. The beam may be reduced in intensity, defocused, and/or scanned at a speed fast enough to not damage the surface of the material but at such a speed that the beam ablates organics and re-deposited metals from the surface while heating the surface to a sufficient temperature to drive off native oxides.

Embodiments described herein generate a clean and prepared surface in the texturing chamber as the texture is applied eliminating the opportunity for contamination build-up prior to the texturizing process. In one embodiment where the energy beam comprises an electron beam the process may be performed in a vacuum chamber so ablated deposits are either re-deposited onto other surfaces or removed from the chamber by the vacuum system. In another embodiment performed in an ambient environment, a suction nozzle or inert gas blow-off may be used to insure that the cleaned area remains clean prior to the texturizing process. This pre-texturing surface modification may be done hole-by-hole, row-by-row, or area-by-area as is appropriate for the component and material being textured.

Embodiments described herein impart additional heat to a component surface prior to the texturizing process, making large features possible and improving the fusion of ejected material to the component surface. Embodiments described herein utilize the ability of the beam to be scanned at speeds sufficiently fast to limit the energy penetration into the component surface such that only the top surface of the component is heated and melted. The beam is passed over the surface where a feature is to be created, the surface surrounding the feature, or both at an energy density and speed sufficient to melt the surface to a desired depth. The depth of the pre-heat melt can be tailored to suit the texture to be applied. Once the pre-heat process is complete the beam makes an immediate pass over the same area to form the final texture. This can be done hole-by-hole, row-by-row, or area-by-area as is appropriate for the component being textured.

It should be understood that in certain embodiments where the “travel speed” of the beam moving relative to the component is discussed, the same “travel speed” may be used to describe the movement of the component relative to the beam. In certain embodiment, both the beam and the component may be moved relative to each other.

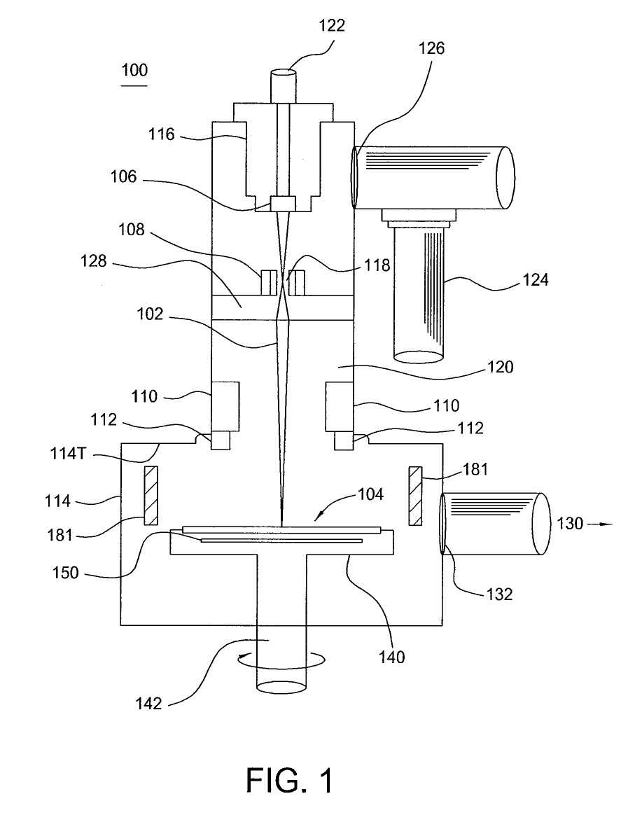

FIG. 1 depicts a cross-sectional, schematic view of surface texturing apparatus 100 that may be used to modify the surface of a component 104. The surface texturing apparatus 100 comprises a column 120. Located within the column is a bias cup 116 surrounding a cathode 106. The cathode 106 may be, for example, a filament comprising a material such as tungsten. A high voltage cable 122 is coupled to the cathode 106 which connects a high voltage power supply to the cathode 106 and the anode 108.

Spaced apart from the cathode 106 and beneath the cathode 106 is an anode 108, and two pairs of high speed deflector coils 112. A pass through hole 118 is formed within the anode 108. A fast focusing coil 110, typically circular in design and concentric with the column 120 is located beneath anode 108. The two pairs of high speed deflector coils 112 reside beneath the fast focusing coil 110. Coupled to, and below the column 120 is a work chamber 114 with a top surface 114T. The work chamber 114 generally comprises a substrate support 140. The substrate support 140 may be coupled to an actuating means 142 for moving the substrate support 140, such as, for example, an actuator or rotating shaft that is capable of translating the component 104 or rotating the component 104 along one or more axes of rotation. An actuating means 142 moves the substrate relative to an electromagnetic beam 102. Electromagnetic beam 102 may be, for example, an electron beam. The substrate support 140 may further comprise a heating element 150, such as, for example, a resistive heater or thermoelectric device. An isolation valve 128 positioned between the anode 108 and the fast focusing coil 110 generally divides column 120, so that the chamber 114 may be maintained at a pressure different from the portion of column 120 above the isolation valve 128. In one embodiment, the beam 102 travels through the focusing coil 110 as well as high speed deflector coils 112.

A pump 124 such as, for example, a diffusion pump or a turbomolecular pump is coupled to column 120 via a valve 126. The pump 124 is used to evacuate column 120. Typically, a vacuum pump 130 is coupled to chamber 114 via an isolation valve 132 in order to evacuate chamber 114. Examples of e-beam devices which can be used or modified and used in processes described herein include electron beam welding systems from Precision Technologies of Enfield, Conn. or from Cambridge Vacuum Engineering of Waterbeach, Cabs, United Kingdom.

In one embodiment, the surface texturing apparatus 100 comprises an energy source 181 mounted near the component 104 that may be used for preheating the component 104 prior to performing the texturizing process. Examples of typical energy sources include, but are not limited to, radiant heat lamps, inductive heaters or IR type resistive heaters. In this configuration the energy source 181 may be turned “on” and maintained for a specified period of time or until the component 104 reaches a desired temperature prior to starting the texturizing process.

While FIG. 1 specifically depicts a surface texturing apparatus comprising an electron beam, embodiments described herein may use any beam of electromagnetic waves or particles, such as, for example, a beam of protons, neutrons, X-rays, a laser, electrical arc, etc. Also the use of the term electromagnetic beam is not meant to be limited to charged particle beams, but is meant to encompass any form of focused energy transferred to the component, for example, an electron beam, a beam of protons or neutrons, X-rays, high intensity optical radiation (e.g. laser), or electrical arc type process (e.g. Electrical Discharge Machining (EDM), etc.). The surface texturing apparatus generally comprises a means for controlling and focusing the particular beam of energy onto the surface of the component. The particular means employed to control and focus the beam generally depends upon the particular type of electromagnetic radiation employed.

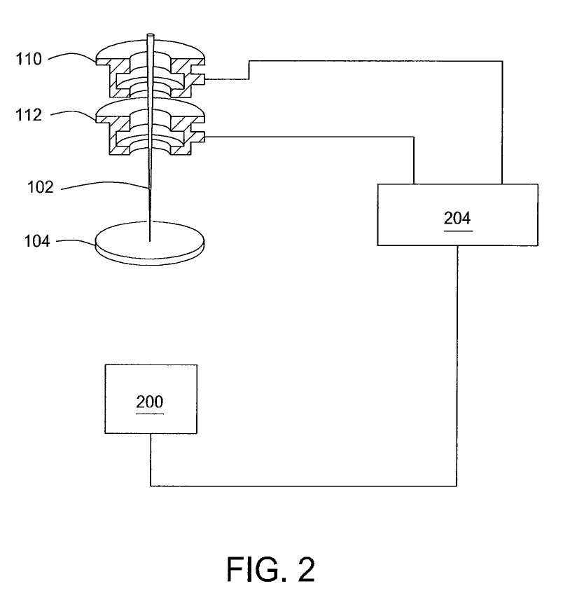

FIG. 2 depicts a schematic, cross-sectional view of a control system that may be coupled to a surface texturing apparatus to practice embodiments described herein. A microprocessor controller 200 is preferably coupled to the focusing coil 110 and high speed deflector coils 112. The microprocessor controller 200 may be one of any form of general purpose computer processor (CPU) that can be used in an industrial setting for controlling various chambers and sub-processors. The computer may use any suitable memory, such as random access memory, read only memory, floppy disk drive, hard disk, or any other form of digital storage, local or remote. Various support circuits may be coupled to the CPU for supporting the processor in a conventional manner. Software routines as required may be stored in the memory or executed by a second CPU that is remotely located.

The software routines are executed upon positioning the component 104 in the chamber 114. The software routine, when executed, transforms the general purpose computer into a specific process computer that controls the chamber operation so that a chamber process is performed. Alternatively, the embodiments described herein may be performed in hardware, as an application specific integrated circuit or other type of hardware implementation, or a combination of software or hardware.

Referring to FIG. 2, typically a set of instructions is encoded onto a computer readable medium which is provided to the controller 200. Control signals produced by executing the instructions are communicated to the fast focusing coil 110 and high speed deflector coils 112 from the controller 200 through one or more function generators 204. In one embodiment, instructions are communicated through five function generators 204. One of the five function generators is used for fast focusing. Two function generators are used for primary beam deflections and two function generators are used for secondary beam deflections. The function generators are accompanied by corresponding power amplifiers (not shown). The instructions typically enable the fast focusing coil 110 and high speed deflector coils 112 to manipulate the electromagnetic beam 102 by moving the beam 102 to a particular location on the surface of the component to create a specific pattern, spacing, and character of features onto the surface of the component 104.

The function generators 204 are capable of generating signal wave shapes over various frequencies. This enables the position and focal diameter of the electromagnetic beam 104 to adjust rapidly to signals originating from controller 200 and enable the rapid formation of features on the surface of the component. The function generators 204 are preferably coupled to one or more power amplifiers, power supplies, etc (not shown) in order to facilitate communication of signals between the controller 200 and the focusing coil 110 as well as the high speed deflector coils 112.

Pre-Clean Process

In one embodiment, the extremely high energy density and fast traverse speeds possible with an energy beam type of texturizing process are utilized to ablate surface contamination from the material surface without melting the surface as an integral part of the texturizing process. Cleaning the surfaces prior to the texturizing process utilizing the electromagnetic beam 102 may be performed in-situ by scanning the beam 102 across the surface of the component 104 in the areas to be textured just prior to the texturing pass by the beam 102. In order to clean the surface prior to texturizing, the beam 102 may be reduced in intensity, defocused, and/or scanned fast enough to not damage the material surface but at such a speed that it ablates organics and re-deposited metals from the surface of the component 104 while heating the surface of the component 104 to a sufficient temperature to drive off native oxides. This pre-clean process generates a clean and prepared surface in the texturing chamber 100 as the texture is applied eliminating the opportunity for contamination build-up prior to texturing.

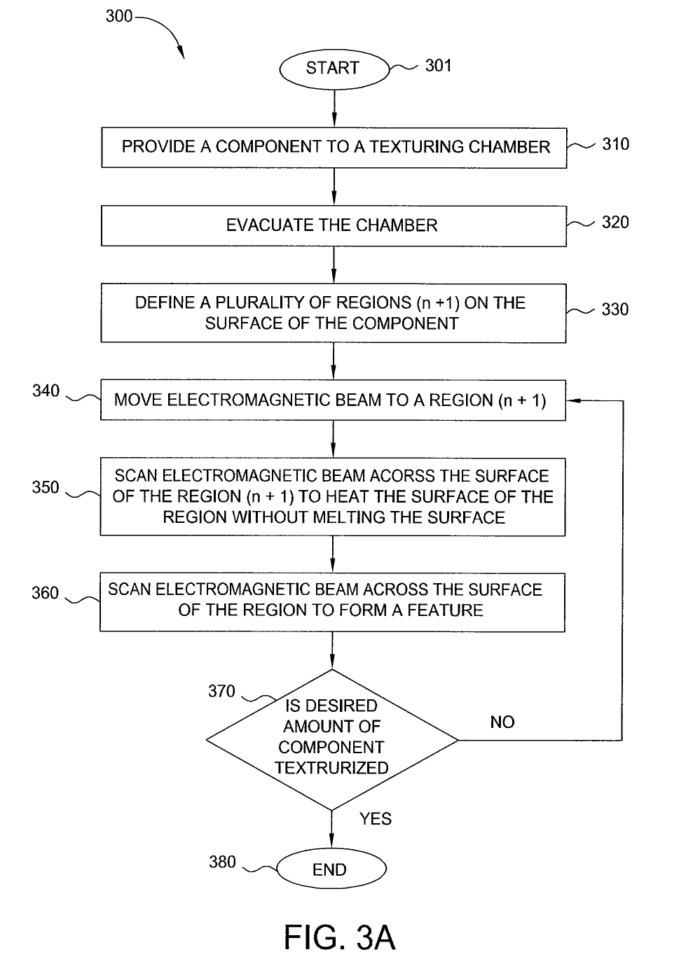

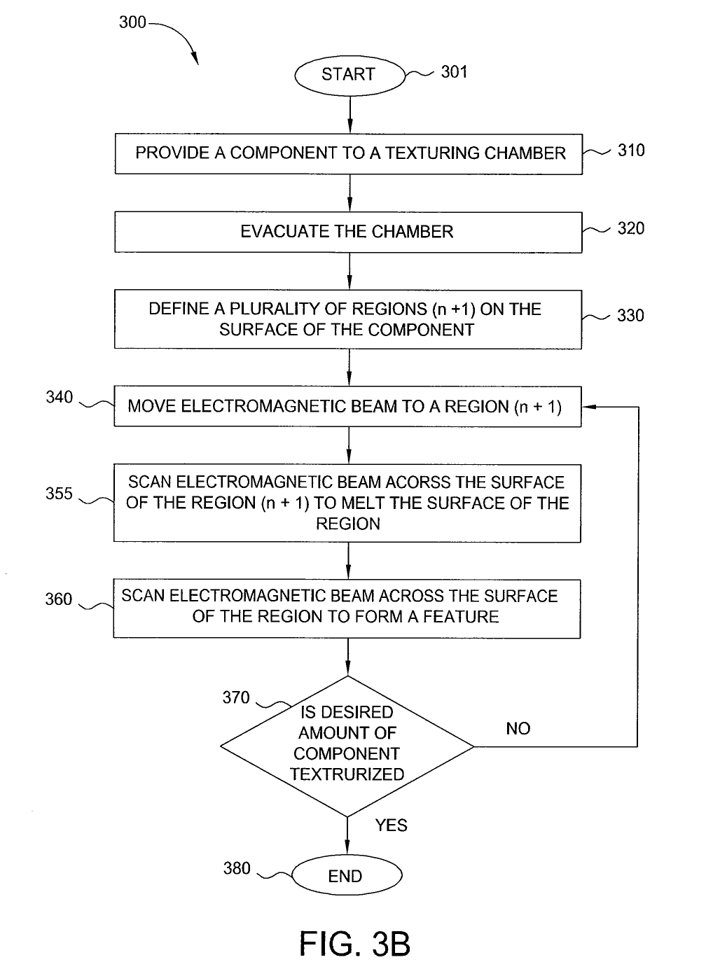

FIG. 3A depicts a process sequence 300, which begins at box 301 and ends with box 380, that may be used to pre-clean a surface of a component 104 prior to modification of the surface of the component 104 according to embodiments described herein. At box 310, a component 104 is positioned in a texturing chamber 100. At box 320, the texturing chamber 100 is evacuated. At box 330, a plurality of regions (n+1, where n=0, 1, 2, 3, 4 . . . ) are defined on the surface of the component 104. At box 340, an electromagnetic beam 102 is moved to a region. At box 350, an electromagnetic beam 102 is scanned across the surface of the region (n+1) to heat the surface of the region without melting the surface of the region. At box 360, an electromagnetic beam 102 is scanned across the surface of the region to form a feature. At box 370, it is determined whether a desired amount of the component 104 has been textured. If a desired amount of the component 104 has been textured, the process ends at box 380. If a desired amount of the component 104 has not been textured, the electromagnetic beam 102 moves to another region (n+1) and the process sequence represented by boxes 340 through 370 is repeated.

Referring to box 310 a component 104 is positioned in a texturizing chamber such as the texturing chamber 114 describe in FIG. 1. In embodiments wherein an electron beam is used, the process may be performed in a vacuum chamber so ablated deposits are either re-deposited onto other surfaces or removed from the chamber 114 by the vacuum pump 130. In embodiments performed in an ambient environment, a suction nozzle or inert gas blow-off may be used to insure that the cleaned region remains clean prior to texturing.

The component 104 may comprise a material such as a metal or metal alloy, a ceramic material, a polymer material, a composite material, or combinations thereof. In one embodiment, the component 104 comprises a material selected from the group comprising steel, stainless steel, tantalum, tungsten, titanium, copper, aluminum, nickel, gold, silver, aluminum oxide, aluminum nitride, silicon, silicon nitride, silicon oxide, silicon carbide, sapphire (Al₂O₃), silicon nitride, yttria, yttrium oxide, and combinations thereof. In one embodiment, the component 104 comprises metal alloys such as austenitic-type stainless steels, iron-nickel-chromium alloys (e.g., Inconel™ alloys), nickel-chromium-molybdenum-tungsten alloys (e.g., Hastelloy™), copper zinc alloys, chromium copper alloys (e.g., 5% or 10% Cr with balance Cu), or the like. In another embodiment, the component comprises quartz. The component 104 may also comprise polymers such as Polyimide (Vespel™), PolyEtherEtherKetone (PEEK), PolyArylate (Ardel™), and the like.

In yet another embodiment, the component 104 may comprises a material such as gold, silver, aluminum silicon, germanium, germanium silicon, boron nitride, aluminum oxide, aluminum nitride, silicon, silicon nitride, silicon oxide, silicon carbide, yttria, yttrium oxide, non-polymers, and combinations thereof.

Referring to box 320, the chamber 114 and column 120 are evacuated to a pressure in the range of about 1×10⁻⁵ torr to about 3×10⁻² torr. In one embodiment, an electromagnetic beam 102 is formed by heating cathode 106 using a resistive heater (not shown) and applying a current to the cathode 106 using a power source (not shown). Electrons escape from the cathode 106 and collect in the bias cup 116. A negative high voltage potential, referred to as an accelerating voltage is applied to the cathode 106 relative to the anode 108 via voltage cable 122 and a secondary negative potential generally smaller in magnitude than the accelerating voltage is applied to the bias cup 116. The accelerating voltage may be in the range of about 50 to about 175 kV. The secondary potential is used to control the magnitude of the electromagnetic beam energy that is delivered to the component 104.

Electrons move through a pass through hole 118 in the anode 108 and begin to diverge. Fast focusing coil 110 located beneath the anode 108 focuses the electromagnetic beam 102 to a narrow diameter on the component 104, while high speed deflector coils 112 magnetically deflect the beam to a particular location of the surface of the component 104. Electrical current is applied to the fast focusing coil 110 and to high speed deflector coils 112 in order to generate sufficient magnetic flux to manipulate the electromagnetic beam 102. Upon passing through fast focusing coil 110 and high speed deflector coils 112, the electron beam is provided to the surface of the component 104. The distance between the top surface 114T of chamber 114 and the component 104 is the working distance of the beam 102. In one embodiment, the working distance is about 50 millimeters to about 1,000 millimeters. In one embodiment, the working distance is between about 200 millimeters to about 350 millimeters.

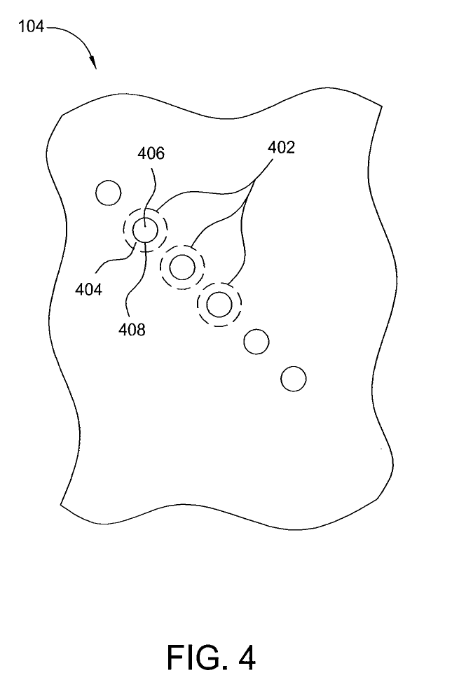

Referring to box 330 and FIG. 4, a plurality of regions (n+1, where n=0, 1, 2, 3, 4 . . . ) are defined on the surface of the component 104. Each of the regions defined on the surface of the component 104 may be sequentially exposed to the electromagnetic beam 102 during the pre-clean and subsequent processing. Each region may comprise a single cell 402 or a plurality of cells. Each cell may comprise an outer area 404 and an inner area 406 where a feature 408 is formed during subsequent processing. In one embodiment, the region may comprise a row or cluster of cells. In one embodiment, each cell may cover an area of between about 0.025 mm² and 16 mm², such as between about 0.0625 mm² (e.g., 0.25 mm×0.25 mm) and about 2.25 mm² (e.g., 1.5 mm×1.5 mm). It should be noted that the shape of the edges of each region may be any shape without varying from the scope of the embodiments described herein.

It should be understood that the plurality of regions may be defined at any time prior to or during the pre-clean process. For example, the plurality of regions may be defined prior to placing the component 104 in the chamber 100. In embodiments where similar components are processed, the plurality of regions may be defined for the first component processed, stored in the controller 200, and used for successively processed components in a feed back type process.

Referring to box 340, the electromagnetic beam 102 is positioned relative to the region. The regions on the surface of the component 104 may be sequentially exposed by translating the output of the electromagnetic beam relative to the component 104 and/or translating the component 104 positioned on the substrate support 140 relative to the output of the electromagnetic beam radiation source (e.g., conventional X/Y stage, precisions stages). The electron beam 102 and/or component 104 may be translated in any direction.

Referring to box 350, the electromagnetic beam 102 is scanned across the surface of the region to heat the surface of the region without melting the surface of the region. The electromagnetic beam 102 may be reduced in intensity, defocused, and/or scanned at a speed fast enough to heat the surface of the region of the component 104 to a temperature to remove organics and re-deposited metals from the surface while heating the surface to a sufficient temperature to drive off native oxides without heating the material surface of the component to a temperature where the component 104 melts, flows, or undergoes substantial decomposition. The pre-clean temperature of the component 104 is generally dependent on the materials the component 104 is constructed from.

The pre-clean scanning step can be conducted by rapidly transferring the electromagnetic beam 102 over the surface of the region in a pattern which heats the region in which the texturizing process is about to be conducted. In one embodiment, the outer area 404 of a cell is pre-cleaned. In another embodiment, the entire cell 402 including the outer area 404 and the inner area 406 is pre-cleaned. In one embodiment, the electromagnetic beam 102, process parameters, such as focal length and process, power, are varied during the process of preheating the component 104. The process parameters used during the pre-clean process may depend on the desired pre-clean temperature, the speed that the beam 102 is transferred across the surface of the component 104, and/or the component material which is being pre-cleaned prior to being texturized.

During the pre-clean scan step, the electromagnetic beam 102 may be moved at a travel speed between about 1 meter per second and 1,000 meters per second, such as between about 1 meter per second and 400 meters per second, for example, between about 1 meter per second and about 100 meters per second. In one embodiment, the component 104 may be moved at a travel speed between about 10 meters per second and 100 meters per second with respect to the electromagnetic beam 102. In general, where the electromagnetic beam 102 is generated by an electron beam, ion beam or electrical arc, an electrical current will flow to the component 104. In one embodiment, where the electromagnetic beam 102 is an electron beam the current may be in the range of about 4 to about 150 milliamperes (mA). In one embodiment, where the electromagnetic beam 102 is an electron beam the current may be in the range of 8 to 45 milliamperes (mA). The energy delivered by the electromagnetic beam 102 can be defined in terms of a power density, which is the average power delivered across a particular cross-sectional area on the surface of the component 104. In one embodiment the average power density of the electromagnetic beam 102 may be, for example, in the range of about 10 KW/mm² to about 500 KW/mm², such as 50 KW/mm² and 250 KW/mm², at a point on the surface of the component 104 upon which the beam is directed. The peak power density of the electromagnetic beam 102 may be, for example, in the range of about 300 KW/mm² to about 350 KW/mm², such as 330 KW/mm², at a point on the surface of the component 104. The peak power density can be defined as a process setting where the beam is at its maximum focus (i.e. smallest possible spot size) at a given power setting. Once pre-cleaning is completed the beam 102 makes an immediate pass over the same area to form the final texture.

In one embodiment, the pre-clean scanning step may be conducted by defocusing and transferring the electromagnetic beam 102 over the surface of the region in a pattern which heats and cleans the region in which the texturizing process is about to be conducted. The texturizing process may then be performed by refocusing and transferring the electromagnetic beam 102 over the surface of the region in the pattern. The process parameters used during the defocusing pre-clean process may depend on the desired pre-clean temperature, the speed that the beam 102 is transferred across the surface of the component 104, and/or the component material which is being pre-cleaned prior to being texturized.

Referring to box 360, after pre-cleaning, the electromagnetic beam 102 is scanned across the surface of the region to form a feature 408 (as shown in FIG. 4). The feature 408 may be a depression, protuberance, or combination thereof. In embodiments where the feature 408 comprises a depression, the depression compresses the material which also reduces the flaking and shedding of particles from process by-products deposited on the component during processing. In one embodiment, the type of feature 408 formed may also depend on the material of the component. For example, where the material of the component is silicon, the feature 408 formed would comprise a protuberance due to thermal expansion of the material. The beam 102 travels through the focusing coil 110 as well as high speed deflector coils 112. The electromagnetic beam 102, for example may be moved at a travel speed in the range of about 0.5 meters per second to about 4 meters per second. In one embodiment, the electromagnetic beam 102 may be moved at a travel speed in the range of about 1 meter per second to about 3 meters per second. In yet another embodiment the electromagnetic beam 102 may be moved at a travel speed in the range of between about 1 meter per second and about 1.7 meters per second. Depending upon the nature of the signals sent from controller 200, through function generators 204, the beam 202 is scanned across pre-cleaned regions of the surface of component 104 resulting in a feature 408 or a plurality of features formed on the surface of the component 104. The features 408 may be in a particular geometric pattern. In one embodiment, the component 104 is moved with respect to the impinging electromagnetic beam 102 during the texturizing process. In one embodiment, the component 104 may, for example, be moved at a travel speed in the range of about 0.5 meters per minute to about 4 meters per minute. In another embodiment, the component may, for example, be moved at a travel speed in the range of about 2 meters per minute to about 3 meters per minute. In yet another embodiment the component may be moved at a travel speed in the range of between about 1 meter per minute and about 1.7 meters per minute, with respect to the electromagnetic beam 102. In one embodiment, the component 104 is rotated along one or more axes of rotation during exposure to the electromagnetic beam 102. The axis of rotation may be, for example, perpendicular or parallel to the incident beam. Due to the size or shape of the component 104 it may be impractical to physically move or rotate the component and thus the electromagnetic beam 102 may be moved across the component 104 to form the desired texture.

In embodiments where the electromagnetic beam 102 is generated by an electron beam, ion beam or electrical arc, an electrical current will flow to the component 104. Where the electromagnetic beam 102 is an electron beam the current may be in the range of about 4 to about 150 milliamperes (mA), preferably 8 to 45 milliamperes (mA). In one embodiment the average power density of the electromagnetic beam 102 may be, for example, in the range of about 10 KW/mm² to about 500 KW/mm², such as 50 KW/mm² and 250 KW/mm², at a point on the surface of the component 104 upon which the beam is directed. The peak power density of the electromagnetic beam 102 may be, for example, in the range of about 300 KW/mm² to about 350 KW/mm², such as 330 KW/mm², at a point on the surface of the component 104. It should be noted that the amount of energy required to form the features 408 on the surface of the component 104 may differ from one type of energy source to another (e.g., electron beam, laser, etc.) due to the efficiency of the absorption or energy transfer to the component 104. The beam density can determine the power densities that are used.

It should also be noted that different power densities can be used with different materials based upon the properties of those materials to achieve different results. The component surface may be modified using a varied approach. For example high powers can be used to sputter and/or dissipate some material and lower powers may be used multiple times to melt and reform surfaces so that material is not vaporized but rather raised features such as protuberances are formed and developed outside of certain areas. Between the low power and the high power density the process can be used to craft desirable features. Depending upon the power density and the feature desired, it is also possible to return to the same are for further modification. For example, in one embodiment, the beam 102 may make multiple passes over the same region to form the features 408 such as both a protuberance and a depression. The melted material from the depression is displaced to form the protuberance. The melted material is allowed to partially solidify and the beam process is repeated to develop the protuberance. The beam process is repeated multiple times depending on the size and shape of the desired feature.

The power or energy delivered to the surface of the component 104 by the electromagnetic beam 102 is not intended to cause significant or gross distortion (e.g., melting, warping, cracking, etc.) of the component 104. Significant or gross distortion of the component 104 can be generally defined as a state where the component 104 is not able to be used for its intended purpose due to the application of the texturizing process. The amount of energy required to cause significant distortion of the component 104 will depend on the material that the component 104 is made from, the thickness and/or mass of the component 104 near the area being texturized, the shape of the component 104 (e.g., flat, cylindrical, etc.), the amount of residual stress in the component 104, the actual power delivered to the component 104, the transfer speed of the beam across the component 104, the density of texturized features 408 on the surface of the component 104, and/or the dwell time of the beam at any point on the component 104. In one embodiment to prevent significant distortion in thin components or components that are sensitive to the thermal stresses induced by the texturizing process, the following steps may be completed: the beam transfer speed may be increased, the beam may be defocused during the transfer time, or the power of the beam may be decreased during the transfer time, in an effort to reduce the energy delivered to the component 104 that is not being used to form the features on the surface of the component 104. To reduce the distortion in components that are susceptible to distortion (e.g., geometrically flat, materials that have a high thermal expansion, etc.) in one embodiment the texturizing process may require texturing on both sides of the component to compensate for the stresses induced by the texturizing process on one side of the component. Additional details of the texturizing process are described in U.S. patent application Ser. No. 6,812,471, titled METHOD OF SURFACE TEXTURIZING, issued Nov. 2, 2004, and U.S. patent application Ser. No. 6,933,508, titled METHOD OF SURFACE TEXTURIZING, issued Aug. 23, 2005 both of which are incorporated herein in their entirety.

Referring to box 370, a determination is made as to whether a desired amount of the component 104 is texturized. If a desired amount of the component 104 has been texturized, the texurization process ends at box 380. If a desired amount of the component 104 has not been texturized, the process sequence of boxes 340 through 370 is repeated.

In embodiments, where the feature 408 comprises a depression, the depression comprises the material which also reduces the flaking and shedding of particles from process-by-products deposited on the component during processing. In one embodiment, the type of feature 408 formed may also depend on the material of the component. For example, where the material of the component is silicon, the feature 408 formed would comprise a protuberance due to thermal expansion of the material.

### Pre-Heating Process

FIG. 3B depicts a process sequence 300 that may be used to pre-heat a material prior to modification of the surface of the material according to embodiments described herein. FIG. 3B describes a process 300 as in FIG. 3A but replaces box 350 with box 355 wherein the electromagnetic beam 102 is scanned across the surface of the region to melt the surface of the region. It should also be understood that boxes 350 and 355 may be performed as part of the same process to provide both a pre-clean and pre-heat prior to texturing a component. This process 300 imparts additional heat to a region prior to texturing to make large feature textures possible and improve the fusion of ejected material with the parent material. The process 300 utilizes the ability of the beam 102 to be scanned at speeds sufficiently fast to limit the energy penetration into the surface of the component 104 such that only the top surface of the component 104 is heated and melted. The beam 102 is scanned over the surface, inner area 406, where a feature 408 such as a hole is to be formed, the outer area 404 (surface just outside of the hole), or both the outer area 404 and the inner area 406, at an energy density and/or speed sufficient to melt the surface of the component 104 to a desired depth. The depth of the pre-heat melt can be tailored to suit the texture to be applied as part of the programming process. Once the pre-heat process is complete the beam 102 makes an immediate pass over the same region to form the final texture.

Referring to box 355, the electromagnetic beam 102 is scanned across the surface of the region to melt the surface of the region. The process may be performed hole-by-hole, row-by-row or area-by-area as is appropriate for the component being textured. The electromagnetic beam 102 is either reduced in intensity, defocused, and/or scanned at a speed fast enough to heat the surface of the component to a temperature to melt the surface of the region of the component 104 to a predetermined depth. The pre-heat temperature of the component 104 is generally dependent on the materials the component 104 is constructed from.

The size of the region pre-heated prior to the formation of features on the region may be determined by the thermal conductivity of the material being worked on. For a material with poor thermal conductivity, a region comprising several cells 402 could be pre-heated prior to texturing the region. However, for a material with good thermal conductivity, it may be possible to only pre-heat one cell 402 prior to texturing the cell. For example, compared to stainless steel, aluminum has a greater thermal conductivity and a lower melting temperature. However, due to the greater thermal conductivity of aluminum, aluminum will dissipate heat and re-solidify at a faster rate than stainless steel. Thus when pre-heating aluminum it may be preferable to pre-heat a smaller region followed by immediate feature formation to avoid the problem of re-solidification. When pre-heating a material with a lower conductivity such as stainless steel it may be possible to pre-heat a larger region prior to texturing the surface.

In one embodiment, the pre-heat scanning of box 355 can be conducted by rapidly transferring the electromagnetic beam 102 over the surface in a pattern which heats the region in which the texturizing process is about to be conducted. In one embodiment, the electromagnetic beam 102 may be moved at a travel speed of about 0.1 meters per second to about 10 meters per second relative to the component 104. In another embodiment, the electromagnetic beam may be moved at a travel speed of about 0.3 meters per second to about 0.5 meters per second. In one embodiment, the electromagnetic beam 102, or other energy source, process parameters, such as focal length and process, power, are varied during, the process of preheating the component 104. The process parameters used during the preheat process may depend on the desired preheat temperature, the speed that the beam is transferred across the surface of the component 104, and/or the component material which is being preheated prior to being texturized. During the pre-heat scan step, the electromagnetic beam 102 may be moved at a travel speed between about 1 meter per second and 100 meters per second.

In one embodiment, during the pre-heat scanning of box 355, the component 104 may be moved at a travel speed between about 0.5 meters per minute and 4.0 meters per minute. In general, where the electromagnetic beam 102 is generated by an electron beam, ion beam or electrical arc, an electrical current will flow to the component 104. Where the electromagnetic beam 102 is an electron beam the current may be in the range of about 4 to about 150 milliamperes (mA). In one embodiment, where the electromagnetic beam 102 is an electron beam the current may be in the range of 8 to 45 milliamperes (mA). In one embodiment the average power density of the electromagnetic beam 102 may be, for example, in the range of about 10 KW/mm² to about 500 KW/mm², such as 50 KW/mm² and 250 KW/mm², at a point on the surface of the component 104 upon which the beam is directed. The peak power density of the electromagnetic beam 102 may be, for example, in the range of about 300 KW/mm² to about 350 KW/mm², such as 330 KW/mm², at a point on the surface of the component 104.

In one embodiment, the pre-heat scanning step can be conducted by defocusing and transferring the electromagnetic beam 102 over the surface of the region in a pattern which heats the region to melt the surface of the region in which the texturizing process is about to be conducted. The texturizing process may then be performed by refocusing and transferring the electromagnetic beam 102 over the surface of the pre-heated region in the pattern. The process parameters used during the defocusing pre-heat process may depend on the desired pre-clean temperature, the speed that the beam 102 is transferred across the surface of the component 104, and/or the component material which is being pre-heated prior to being texturized.

In one embodiment, an electromagnetic beam 102 that forms a spiral pattern may be used. The electromagnetic beam 102 can pre-heat the surface of the outer area 404 where a feature 408 such as a hole is to be created at an energy density and speed sufficient to melt the surface to a desired depth. As the spiral tightens, the speed of the electromagnetic beam 102 is decelerated to melt the inner area 406 or center forming the feature 408.

### Thermal Gasket

Embodiments described herein further provide a component such as a gasket with a modified surface formed according to embodiments described herein. Embodiments of the component may be used for thermal transmission between components located in systems included but not limited to high vacuum process chambers, electronic systems, power generation systems, automotive engine, cooling systems, lighting systems, and anywhere where heat needs to be transferred from one component to another.

Components bolted together typically demonstrate acceptable thermal transfer in the area immediately surrounding the bolt locations. However, while acceptable thermal transfer is present in the zones immediately surrounding each bolt there is poor thermal transfer in the spaces between the bolt locations. Embodiments described herein provide a compliant component such as a gasket comprising a metal with high thermal conductivity and modified to insure conformal contact and good thermal transfer between components.

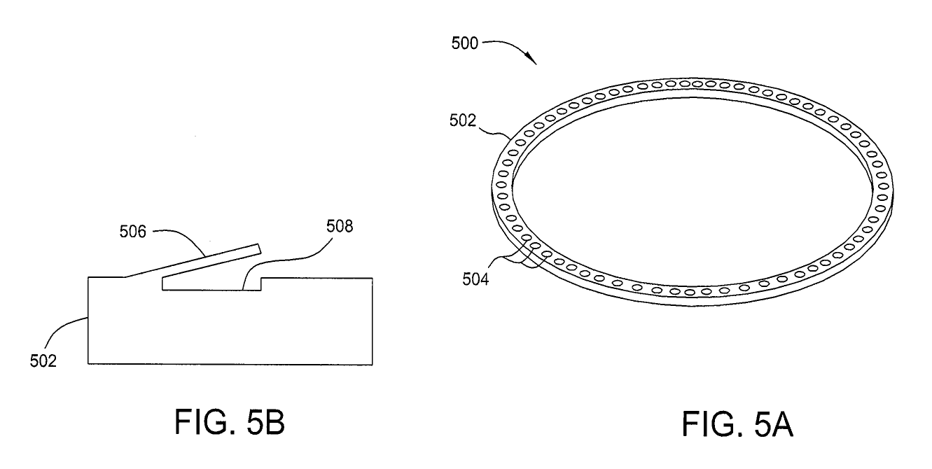

FIG. 5A depicts a perspective view of a component according to embodiments described herein and FIG. 5B depicts a partial side view of the component of FIG. 5A. In one embodiment, a component 500 such as a gasket comprising metal is provided. The component 500 has an annular body 502 having a large number of features 504 formed upon the annular body 502. In one embodiment, the features comprise protuberances 506 and depressions 508. In one embodiment, the protuberances 506 have a width between about 200 micrometers and about 2000 micrometers. In another embodiment, the protuberances have a width between about 500 micrometers and about 1,000 micrometers. In another embodiment, the protuberances are generated in the dead-soft state reducing the temper of the metal and insuring the ability of the gasket to yield and conform during clamping of the parts around the gasket.

The formation of the protuberances 506 is associated with the formation of depressions 508 in the metal surrounding the protuberances such that the protuberances 506 have a depression 508 to drop into as the surrounding parts are clamped together. The protuberances 506 and depressions 508 may be of any shape. The features 504 can be tailored to yield a gasket with controlled compression to insure repeatable stack height of the assembled parts. The protuberances 506 and the depressions 508 may be formed using a scanning electron beam of sufficient power to move metal from one location of the component to another location.

In one embodiment, the gasket material may be selected from the group comprising aluminum, copper, lead, steel, tin, alloys thereof, and combinations thereof. In one embodiment, the gasket material may comprise any metal material compatible with process chemistries.

Embodiments described herein provide methods of surface preparation using an electromagnetic beam prior to modification of the surface of a component which advantageously improves the quality of the final texture in those places and correspondingly reduces particle contamination.

While the foregoing is directed to embodiments of the present invention, other and further embodiments of, the invention may be devised without departing from the basic scope thereof, and the scope thereof is determined by the claims that follow.

1. A method of providing a texture to a surface of a component for use in a semiconductor processing chamber, comprising:
defining a plurality of regions on the surface of the component;
moving an electromagnetic beam to a first region of the plurality of regions;
scanning the electromagnetic beam across a surface of the first region to heat the surface of the first region; and
scanning the electromagnetic beam across the heated surface of the first region to form a feature.

2. The method of claim 1, further comprising:
moving the electromagnetic beam to a second region of the plurality of regions;
scanning the electromagnetic beam across a surface of the second region to heat the surface of the second region; and
scanning the electromagnetic beam across the heated surface of the second region to form a feature.

3. The method of claim 1, wherein the scanning the electromagnetic beam across a surface of the first region to heat the surface of the first region comprises heating the surface of the first region to a temperature that is less than a temperature at which the component begins to melt, flow, or undergo substantial decomposition.

4. The method of claim 1, wherein the scanning the electromagnetic beam across a surface of the first region to heat the surface of the first region comprises melting the surface of the first region to a predetermined depth.

5. The method of claim 1, wherein the scanning the electromagnetic beam across the heated surface of the first region to form a feature occurs immediately after the scanning the electromagnetic beam across a surface of the first region to heat the surface of the first region.

6. The method of claim 1, further comprising defocusing the electromagnetic beam prior to the scanning the electromagnetic beam across a surface of the first region to heat the surface of the first region.

7. The method of claim 6, further comprising refocusing the electromagnetic beam after the scanning the electromagnetic beam across a surface of the first region to heat the surface of the first region and prior to the scanning the electromagnetic beam across the heated surface of the first region to form a feature.

8. The method of claim 1, wherein the electromagnetic beam scanned across the surface of the first region to form a feature has a power density greater than the power density of the electromagnetic beam scanned across a surface of the first region to heat the region.

9. The method of claim 1, wherein the scanning the electromagnetic beam across a surface of a first region to heat the first region comprises moving the electromagnetic beam at a travel speed relative to the component so the electromagnetic beam does not melt the surface of the region but removes contaminants from the surface.

10. The method of claim 9, wherein the travel speed relative to the component is between about 10 meters per second and 100 meters per second.

11. The method of claim 10, wherein the scanning the electromagnetic beam across the heated surface of the first region to form a feature further comprises moving the electromagnetic beam at a travel speed of between about 0.5 meters per second and about 4 meters per second.

12. The method of claim 1, wherein the component comprises a material selected from the group consisting of: steel, stainless steel, tantalum, tungsten, titanium, copper, aluminum, nickel, gold, silver, aluminum oxide, aluminum nitride, silicon, silicon nitride, silicon oxide, silicon carbide, sapphire (Al₂O₃), silicon nitride, yttria, yttrium oxide, and combinations thereof.

13. The method of claim 1, wherein the component comprises a material selected from the group comprising: gold, silver, aluminum silicon, germanium, germanium silicon, boron nitride, aluminum oxide, aluminum nitride, silicon, silicon nitride, silicon oxide, silicon carbide, yttria, yttrium oxide, non-polymers, and combinations thereof.

14. The method of claim 1, wherein the features formed are selected from the group consisting of depressions, protuberances, and combinations thereof.

15. A method of providing a texture to a surface of a component for use in a semiconductor processing chamber, comprising:
scanning an electromagnetic beam across a first region of a plurality of regions of the surface of the component for a first time period to heat a surface of the first region of the component without melting the component; and
scanning the electromagnetic beam across the surface of the first region of the component for a second time period to form a feature on the surface of the first region of the component, wherein the second time period begins immediately after completion of the first time period.

16. The method of claim 15, further comprising:
scanning the electromagnetic beam across a second region of the plurality of regions of the surface of the component to heat a surface of the second region of the component without melting the component; and
scanning the electromagnetic beam across the surface of the second region of the component for a sufficient time period to form a feature on the second region.

17. The method of claim 15, further comprising defocusing the electromagnetic beam prior to the scanning an electromagnetic beam across a first region of a plurality of regions of the surface of the component for a first time period to heat a surface of the first region.

18. The method of claim 17, further comprising refocusing the electromagnetic beam after the scanning an electromagnetic beam across a first region of a plurality of regions of the surface of the component for a first time period to heat a surface of the first region of the component without melting the component and prior to scanning the electromagnetic beam across the surface of the first region of the component for a second time period to form a feature.

19. The method of claim 15, wherein the scanning the electromagnetic beam across a surface of a first region to heat the first region comprises moving the electromagnetic beam at a travel speed relative to the component so the electromagnetic beam does not melt the surface of the region but removes contaminants from the surface to provide a clean surface and wherein the travel speed relative to the component is between about 0.1 meters per second and 10 meters per second.

20. A method of providing a texture to a surface of a component for use in a semiconductor processing chamber, comprising:
scanning an electromagnetic beam across a first region of a plurality of regions of the surface of the component for a first time period to melt the surface of the component; and
scanning the electromagnetic beam across the first region of the surface of the component for a second time period to form a feature on the first region of the surface of the component, wherein the second time period begins immediately after completion of the first time period, wherein scanning the electromagnetic beam across the heated surface of the first region to form a feature occurs immediately after scanning the electromagnetic beam across a surface of the first region to heat the surface of the region.
